(19) United States
(12) Patent Application Publication
(10) Pub. No.: US 2014/0333678 A1
(43) Pub. Date: Nov. 13, 2014

(54) DISPLAY APPARATUS FOR SWITCHING 2D MODE AND 3D MODE

(71) Applicant: KOREA INSTITUTE OF SCIENCE AND TECHNOLOGY, Seoul (KR)

(72) Inventors: Sung Kyu KIM, Seoul (KR); Ki Hyuk YOON, Seoul (KR)

(73) Assignee: KOREA INSTITUTE OF SCIENCE AND TECHNOLOGY, Seoul (KR)

(21) Appl. No.: 14/098,778

(22) Filed: Dec. 6, 2013

(30) Foreign Application Priority Data
May 7, 2013 (KR) 10-2013-0051428

(51) Int. Cl. G09G 5/10

(52) U.S. Cl. CPC G09G 5/10
USPC 345/690

(57) ABSTRACT

Disclosed is an image display apparatus for switching a two-dimensional (2D) mode and a three-dimensional (3D) mode. The image display apparatus includes a display panel in which pixels are arranged, a back light line source arranged so as to be spaced apart from the display panel, a fixed light diffusion plate arranged between the display panel and the back light line source, and a control unit controlling to switch the 2D mode and the 3D mode, wherein 3D line sources forming at least one set are arranged in the back light line source so as to be spaced apart from each other at regular intervals, and a 2D line source is arranged between the 3D line sources arranged so as to be spaced apart from each other.

### CROSS-REFERENCE TO RELATED APPLICATION

This application claims priority to and the benefit of Korean Patent Application No. 2013-0051428, filed on May 7, 2013, the disclosure of which is incorporated herein by reference in its entirety.

### BACKGROUND

1. Field of the Invention The present invention relates to a three-dimensional (3D) image display apparatus, and more particularly, to an image display apparatus which may switch a two-dimensional (2D) mode and a 3D mode without an additional electronic device by applying a fixed light diffusion plate between a line source and a display panel for the purpose of switching to the 2D mode in an autostereoscopic 3D image display apparatus including a plurality of line source sets.

2. Discussion of Related Art

In an autostereoscopic three-dimensional (3D) image display apparatus according to the prior art, a parallax separation means is disposed in front of an existing two-dimensional (2D) image display apparatus. Thus, images having different parallax are transmitted to left and right eyes of an observer, and therefore three-dimensional (3D) stereoscopic images are actually provided to the observer. As the parallax separation means for providing such 3D stereoscopic images, a parallax barrier plate and a lenticular lens sheet may be used. In addition, a method of implementing autostereoscopic display by applying a back light line source to a rear surface of a transmissive type display may be used. A schematic example of a stereoscopic image display apparatus to which such a line source is applied is shown in FIG. 1.

FIG. 1 is a conceptual diagram showing a 3D image display apparatus of two viewing zones using a back light line source according to the prior art. Referring to FIG. 1, the 3D image display apparatus includes a line source array in which the line sources are arranged on a rear surface of a display panel of a general 2D image display apparatus so as to be spaced apart from each other. Pixels formed on the display panel include left-eye image pixels and right-eye image pixels. A back light line source array consists of a region in which the line sources are disposed and a region in which the line sources are not disposed. A width of the line source in the drawing is Wt, and a pitch between adjacent line sources is Ls.

However, since an image viewed by an observer is not always a 3D image, there is a demand for an image display apparatus for switching a 3D mode and a 2D mode. In the image display apparatus for switching the 3D mode and the 2D mode, the 3D mode and the 2D mode may be electronically switched by a liquid crystal parallax barrier method in a 3D image display apparatus using a parallax barrier and by a liquid crystal lenticular lens method in a 3D image display apparatus using a lenticular lens.

In the 3D image display apparatus using the back light line source, a typical method of switching a 2D mode and a 3D mode is electronically switching a 2D mode and a 3D mode by applying a polymer dispersed liquid crystal (PDLC) between the display panel and the back light.

However, such an existing method of switching the 2D mode and the 3D mode has problems such as degradation in image quality of a planar image in the 2D mode due to transmission efficiency, uniformity and efficiency of a condition of a light diffusion plate, non-uniformity of light distribution of a line source at a position of an electronic light diffusion plate, and the like.

### SUMMARY OF THE INVENTION

The present invention is directed to an autostereoscopic image display apparatus to which a back light line source is applied, and more specifically, to an image display apparatus which may effectively switch a three-dimensional (3D) display mode and a two-dimensional (2D) display mode while ensuring uniformity of light distribution of back light in the 2D display mode.

According to an aspect of the present invention, there is provided an image display apparatus for switching a 2D mode and a 3D mode, including: a display panel in which pixels are arranged; a back light line source arranged so as to be spaced apart from the display panel; a fixed light diffusion plate arranged between the display panel and the back light line source; and a control unit controlling to switch the 2D mode and the 3D mode, wherein 3D line sources forming at least one set are arranged in the back light line source so as to be spaced apart from each other at regular intervals, and a 2D line source is arranged between the 3D line sources arranged so as to be spaced apart from each other.

In this instance, preferably, in at least two 3D line source sets, the 3D line sources forming each set and corresponding 3D line sources forming other sets may be arranged adjacent to each other. Preferably, the control unit may control a switch so as to apply a voltage only to the 3D line source when driven in the 3D mode and apply a voltage to both the 3D line source and the 2D line source when driven in the 2D mode.

Preferably, the display panel may be a display panel of a non-emissive optical modulation scheme which includes a liquid crystal display (LCD), a Ferro electric liquid crystal display (FLCD), a digital micro-minor display (DMD), and a grating light valve (GLV).

The 3D line source and/or the 2D line source may be formed by point light sources.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a conceptual diagram illustrating a three-dimensional (3D) image display apparatus of two viewing zones which uses a back light line source according to the prior art;

FIG. 2 is a conceptual diagram illustrating a method of switching a two-dimensional (2D) mode and a 3D mode according to the prior art, which applies a polymer dispersed liquid crystal (PDLC) between the display panel and the back light and electrically switches PDLC;

FIG. 3 is a conceptual diagram illustrating a case of a 2D mode in an image display apparatus for switching a 2D mode and a 3D mode according to an embodiment of the present invention;

FIG. 4 is a conceptual diagram illustrating a case of a 3D mode in an image display apparatus for switching a 2D mode and a 3D mode according to an embodiment of the present invention;

FIG. 5 is a circuit diagram illustrating driving of a back light line source of the image display apparatus for switching the 2D mode and the 3D mode shown in FIGS. 3 and 4;

FIGS. 6A to 6C arc conceptual diagrams illustrating an image display apparatus for switching a 2D mode and a 3D mode according to another embodiment of the present invention;

FIG. 7 is a circuit diagram illustrating driving of a back light line source of the image display apparatus for switching the 2D mode and the 3D mode shown in FIGS. 6A to 6C;

FIG. 8 is a diagram illustrating an example of arrangement of effective line sources shown in a fixed light diffusion plate in a case in which only a 3D line source among back light line sources is driven; and

FIGS. 9A to 9C are diagrams illustrating a variety of implementation examples of line sources for 3D and additional line sources for 2D which are arranged in a back light line source.

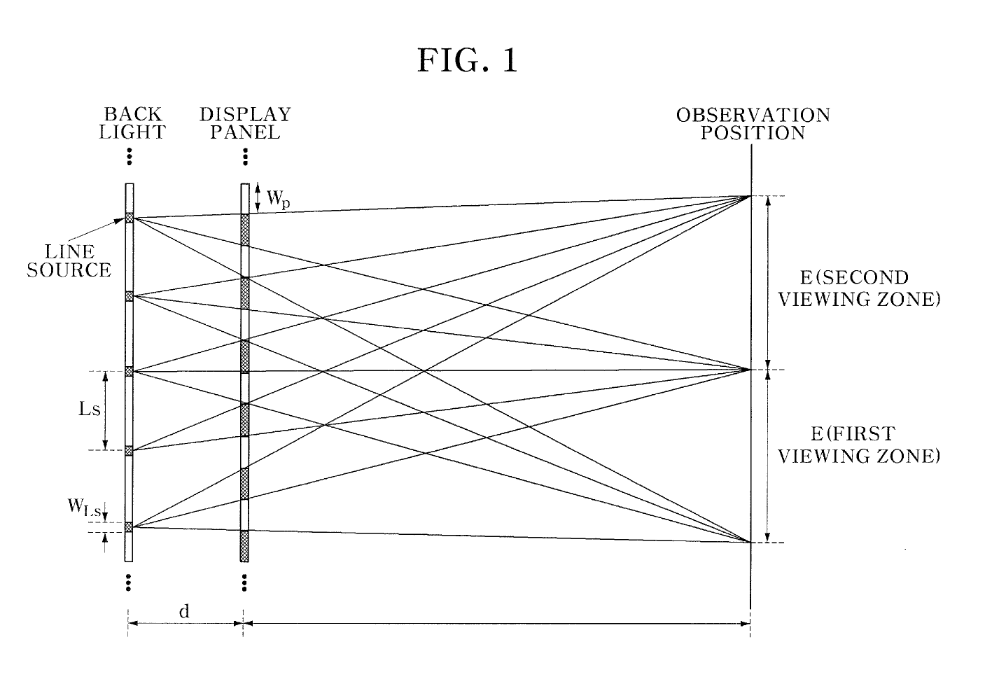

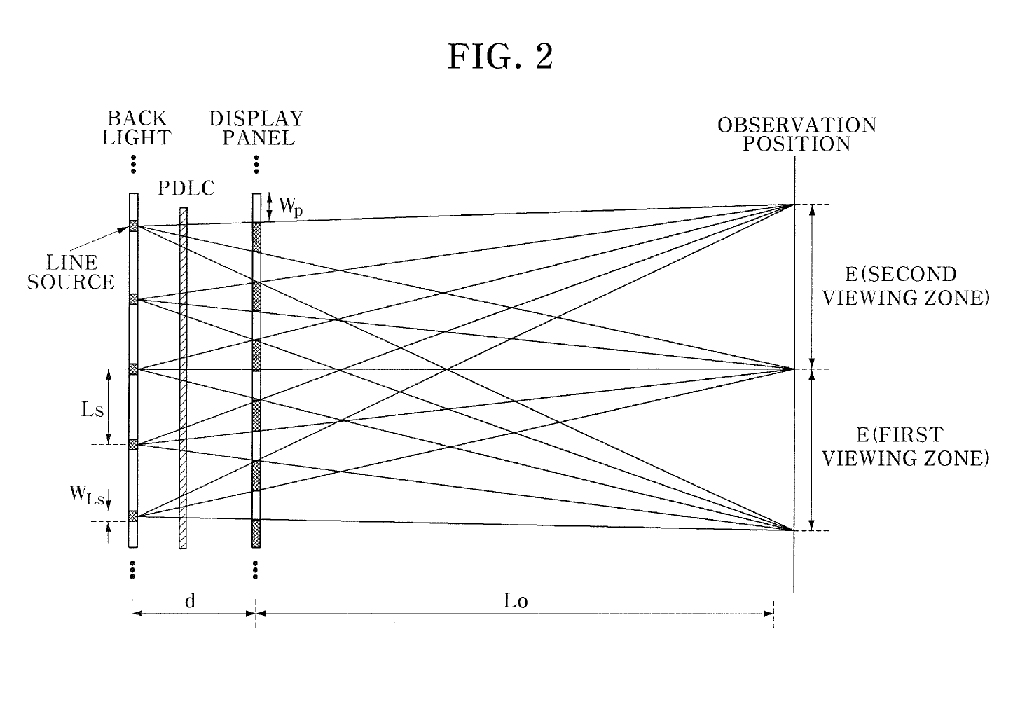

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Hereinafter, embodiments of the present invention will be described in detail.

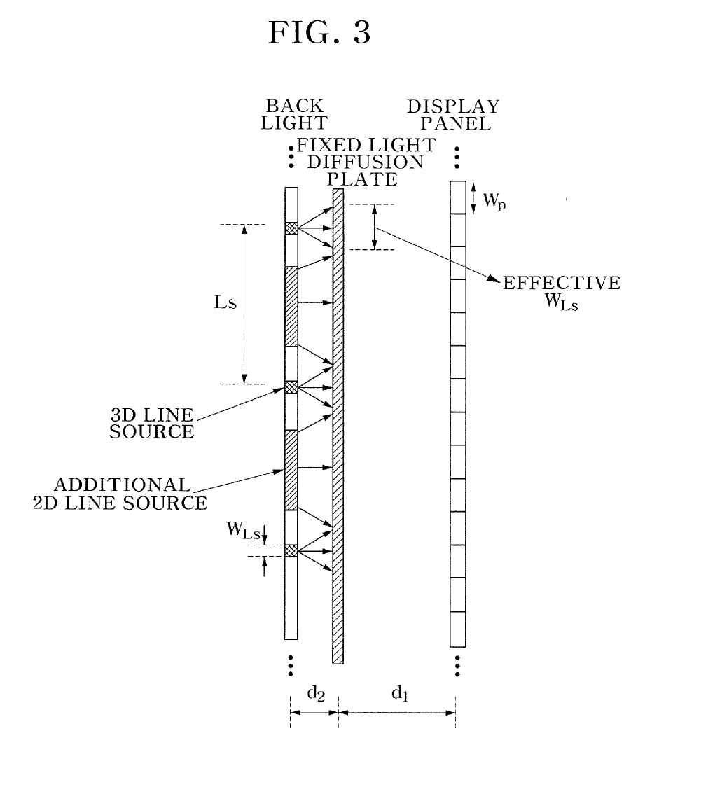

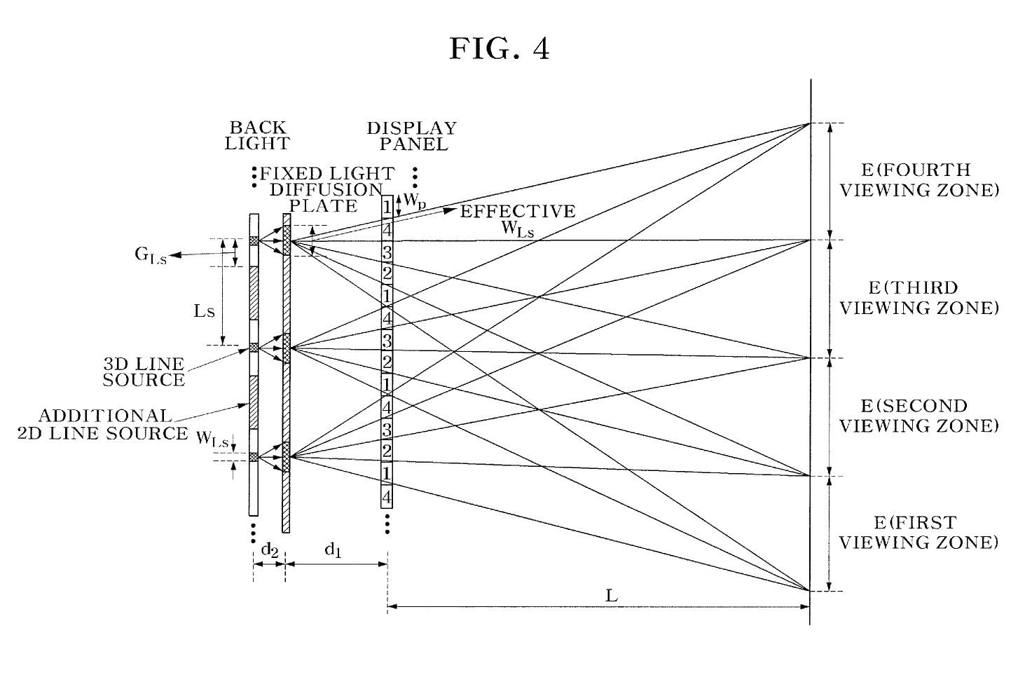

FIGS. 3 and 4 are conceptual diagrams illustrating an image display apparatus for switching a two-dimensional (2D) mode and a three-dimensional (3D) mode according to an embodiment of the present invention. FIG. 3 shows an image display apparatus in a 2D mode, and FIG. 4 shows an image display apparatus in a 3D mode.

Referring to FIGS. 3 and 4, a fixed light diffusion plate is arranged between a display panel and a back light line source. In addition, in the back light line source, line sources for 2D implementation are additionally arranged in empty spaces between the line sources for 3D implementation. Thus, a control unit (not shown) drives the additional 2D line source simultaneously with the 3D line source in the 2D mode as shown in FIG. 3, and drives only the 3D line source in the 3D mode as shown in FIG. 4 while switching off the additional 2D line source.

As the display panel, a display panel of non-emissive optical modulation scheme such as a liquid crystal display (LCD), a Ferro electric liquid crystal display (FLCD), a digital micro-mirror display (DMD), a grating light valve (GLV), or the like may be adopted.

The fixed light diffusion plate may diffuse light across a display panel, and diffuse light from a light source along a surface so that color and brightness of the entire display panel are wholly and uniformly viewed.

The fixed light diffusion plate is arranged between the display panel and the back light line source, and as shown in the 2D mode of FIG. 3, light from each line source is determined so as to be close to each other, adjacent to each other, or has a narrow separation therebetween in the fixed light diffusion plate in accordance with intervals between the 3D line source and the additional 2D line source. That is, the fixed light diffusion plate between the display panel and the back light line source may be arranged in a position in which uniform light distribution can be implemented even in the 2D mode in consideration of a diffusion angle of each line source and an interval between the line sources.

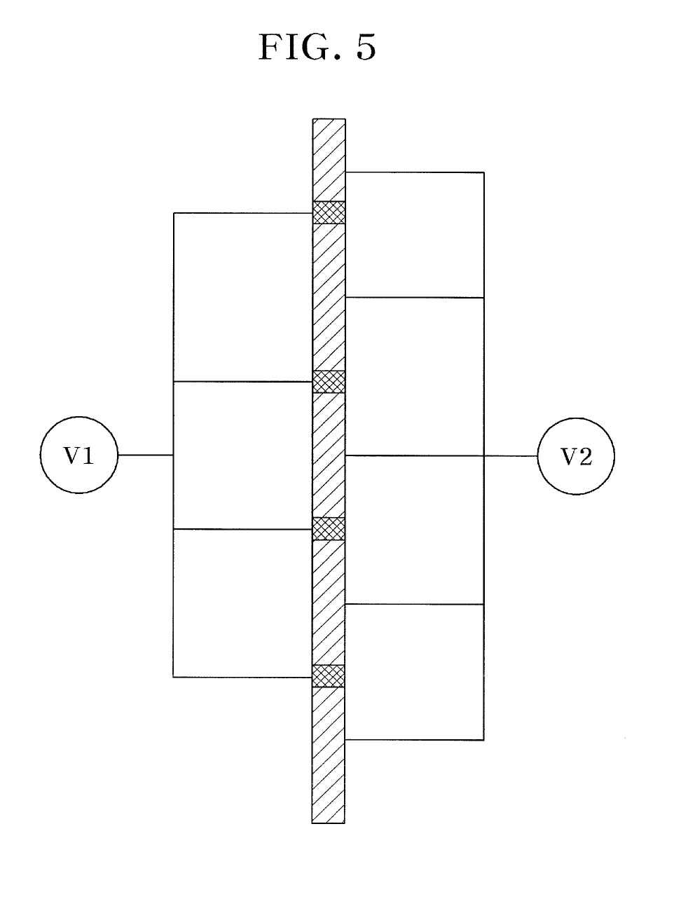

FIG. 5 is a circuit diagram illustrating driving of a back light line source of the image display apparatus for switching the 2D mode and the 3D mode shown in FIGS. 3 and 4. As shown in FIG. 4, a voltage should be applied only to the 3D line source in order to drive in the 3D mode, and therefore only V1 is driven. However, as shown in FIG. 3, a voltage should be applied to both the 3D line source and the 2D line source in order to drive in the 2D mode, and therefore V1 and V2 are simultaneously driven. In accordance with operation of V1 and V2 applied to the back light line source, 3D image information and 2D image information are appropriately arranged on the display panel, thereby switching and implementing the 3D mode and the 2D mode. In particular, in a case in which only the 3D line source shown in FIG. 4 is driven by applying V1 to the 3D line source in FIG. 5, light emitted from the 3D line source has a line width in the fixed light diffusion plate that is arranged at a distance of d2 from backlight larger than a line width (W_{LS}) of each line source.

However, in a case in which the line width of the light emitted from the 3D line source in the fixed light diffusion plate is referred to as an effective W_{LS}, when the display panel is arranged at a distance of d1 from the line source having the effective W_{LS} on the fixed light diffusion plate and a viewpoint image designed on the display panel is provided, a 3D image may be observed from an observer position. In FIG. 4, on the fixed light diffusion plate that is arranged so as to be spaced apart, by d1, from the display panel on which four viewpoint images are designed, four viewing zones are formed so as to be separated, at a designed viewpoint interval E, from a designed observer position (L) through light emitted from the line source having the effective W_{LS}. On the other hand, as shown in FIG. 3, when applying a voltage V2 to the additional 2D line source through the control unit of FIG. 5 together with the 3D line source, light emitted from the 3D line source and light emitted from the additional 2D line source adjacent to the light from the 3D line source are mutually diffused on the fixed light diffusion plate that is arranged at an adjacent appropriate distance of d2, thereby providing the same effects as a uniform surface light source after the fixed light diffusion plate. In this case, when supplying 2D images to pixels of the display panel, a 2D screen having the same resolution as the existing can be simply viewed.

Through the method which has been described with reference to FIGS. 3 to 5, a uniform back light may be obtained in the 2D mode, and a unique 3D display mode other than an increase in the line width of the line source compared to an initial 3D line source due to positioning of the fixed light diffusion plate may be implemented in the 3D mode.

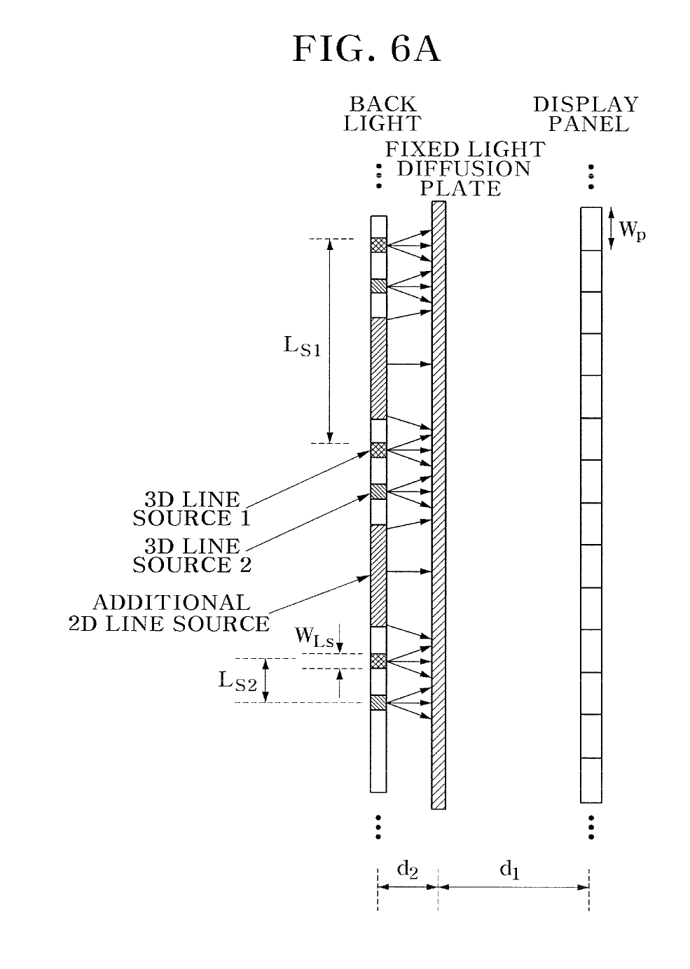

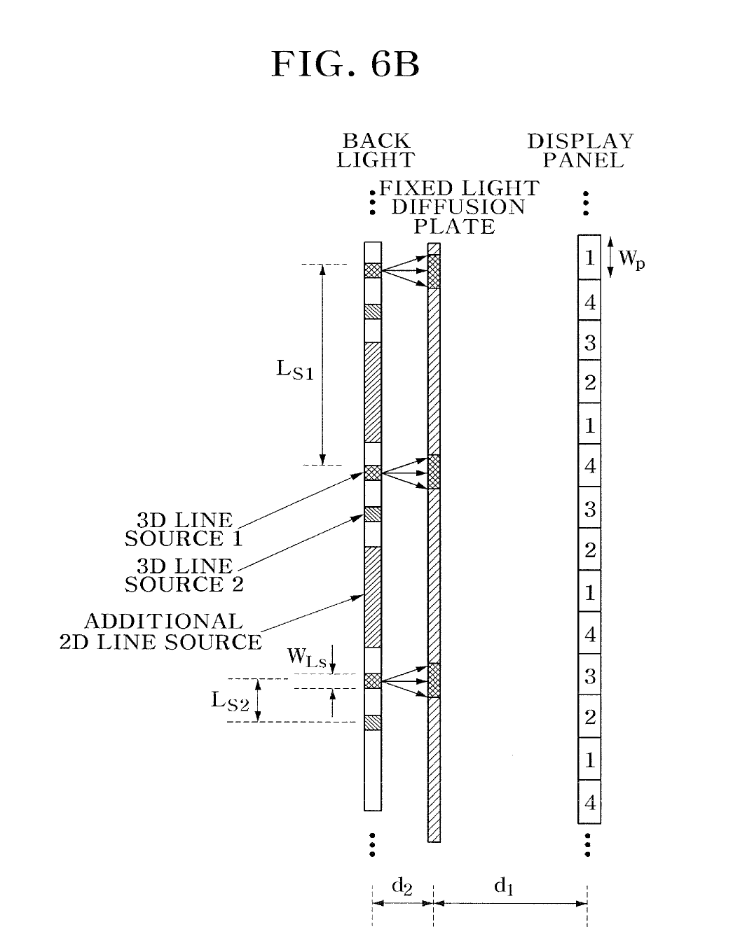

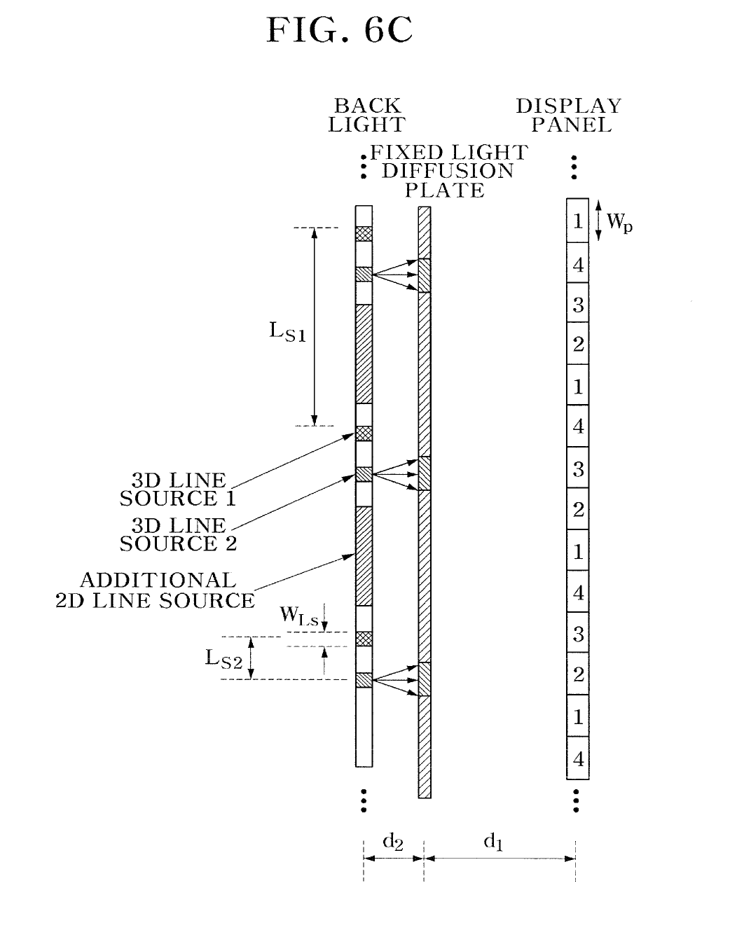

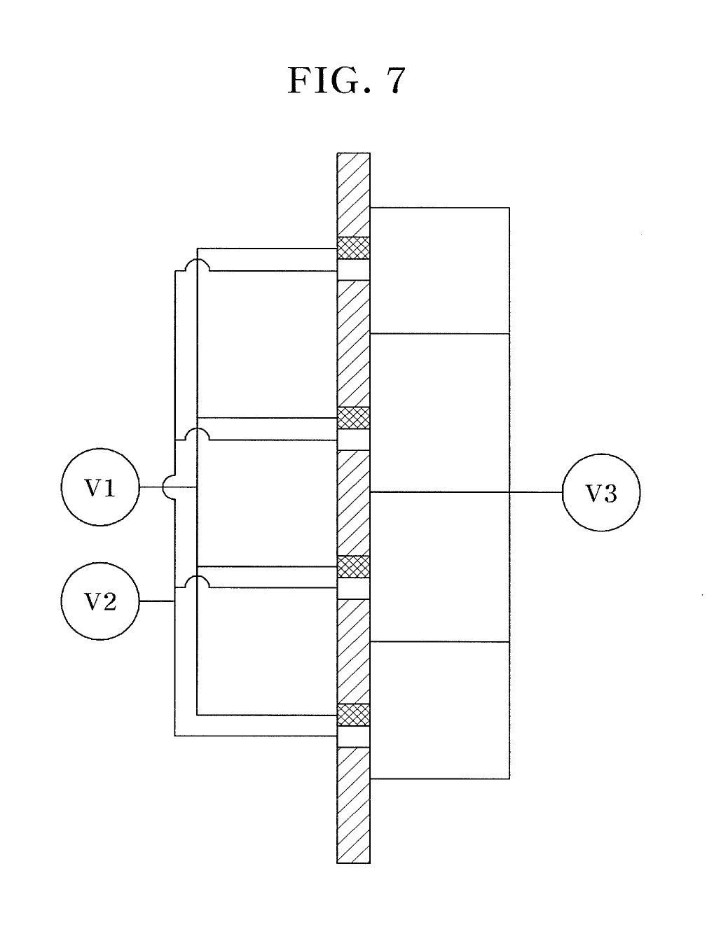

FIGS. 6A to 6C are conceptual diagrams illustrating an image display apparatus for switching a 2D mode and a 3D mode according to another embodiment of the present invention, and FIG. 7 is a circuit diagram illustrating driving of a back light line source of an image display apparatus for switching a 2D mode and a 3D mode according to another embodiment of the present invention.

In FIGS. 3 and 4, an example of an image display apparatus only using a single 3D line source set has been described, but as shown in examples of FIGS. 6A to 6C, two 3D line source sets or more for changing a 3D viewing zone forming position in conjunction with an observer position may be obviously applied. The two 3D line source sets or more are not described in the present invention, but may be used even in forming a time-division type 3D viewing zone in accordance with a driving method of the 3D line source.

As shown in the examples of FIGS. 6A to 6C, when the two 3D line sources are arranged, arrangement of the 2D line sources additionally arranged in empty spaces between the 3D line sources is the same as the arrangement of a single 3D line source which has been made with reference to FIGS. 3 and 4. In addition, an application method such as arranging the fixed light diffusion plate between the display panel and the back light line source, making the interval between the line sources close to each other, and the like is the same as in FIGS. 3 and 4.

FIG. 7 is a circuit diagram illustrating driving of a back light line source of an image display apparatus for switching a 2D mode and a 3D mode according to another embodiment of the present invention. Hereinafter, 2D/3D switching and a method of driving two 3D line sources will be specifically described with reference to FIGS. 6A to 6C and FIG. 7.

In order to drive the image display apparatus in the 2D mode, a voltage is applied to all of V1, V2, and V3 of FIG. 7. When driving all of the 2D line source and the two 3D line source sets in this manner, a uniform surface light source is emitted through the fixed light diffusion plate arranged on the entire surface of the back light line source so as to be spaced apart by a predetermined distance as shown in FIG. 6A, so that 2D images supplied from the pixels arranged in the display panel may be viewed by an observer.

When driving the image display apparatus in the 3D mode, V3 of FIG. 7 is not driven so that the 2D line source is not operated, and V1 and V2 are selectively driven so that only a single line source set of the two 3D line source sets is driven. As an embodiment, in FIG. 6B, in a case in which only a first 3D line source set is driven, the effective line source formed on the fixed light diffusion plate is shown. In this instance, the display panel is formed so as to be spaced, at regular intervals, apart from the fixed light diffusion plate in which the effective line source is formed, and viewpoint images are horizontally arranged on the display panel. In FIG. 6B, an example in which four viewpoint images are arranged on the display panel is shown.

On the other hand, in FIG. 6C, an effective line source formed on the fixed light diffusion plate in a case in which only a second 3D line source set is driven is shown. A position of each of a first effective line source on the fixed light diffusion plate formed by the first 3D line source set as shown in FIG. 6B and a second effective line source on the fixed light diffusion plate formed by the second 3D line source set as shown in FIG. 6C are moved in a horizontal direction. By the line source set moved in the horizontal direction by selectively driving the two line sources like such an embodiment and by pixels in which viewpoint images are arranged on the display panel, a position of a viewing zone formed in a position of an observer may be horizontally moved. That is, although not shown, the position of the observer may be fed back by an observer position tracking system, and only a single 3D line source set may be selected from at least two 3D line source sets so that a 3D image in which a crosstalk is minimized can be viewed in the position of the observer by the observer while the observer is moving.

In such 3D line sources, a plurality of line sources are gathered to form a single set, and the 3D line sources forming each set and corresponding 3D line sources forming other sets may he arranged adjacent to each other. That is, the 3D line source forming a first set, the 3D line source forming a second set, the 3D line source forming a third set, . . . , and the 3D line source forming an nth set are subsequently arranged. Next, it is preferable that the 2D line source be arranged, and then the 3D line source forming the first set be arranged again.

The back light line source may be implemented in a variety of methods, and a method of simultaneously driving a plurality of point light sources arranged on an optical plate along columns may be used. In this instance, when the 3D back light line source is formed in another arbitrary form or consists of point light sources which is different from a general line source, the additional 2D line source may be formed in the arbitrary form or applied to an area excluding the point light sources.

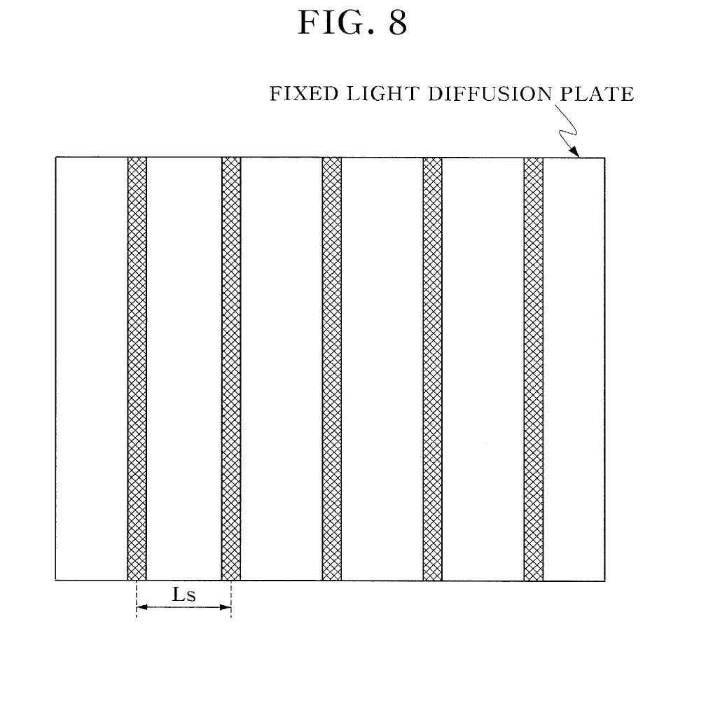

In FIG. 8, an example in which arrangement of the effective line sources shown on the fixed light diffusion plate is viewed from the front surface in a case in which only the 3D line source is driven among the back light line sources as shown in FIGS. 4, 6B, or 6C is shown. In the embodiment, a vertical line source formed on the fixed light diffusion plate is shown, but a line source that is inclined at a predetermined angle in a vertical direction in accordance with arrangement of 3D viewpoint images of the display panel may be used.

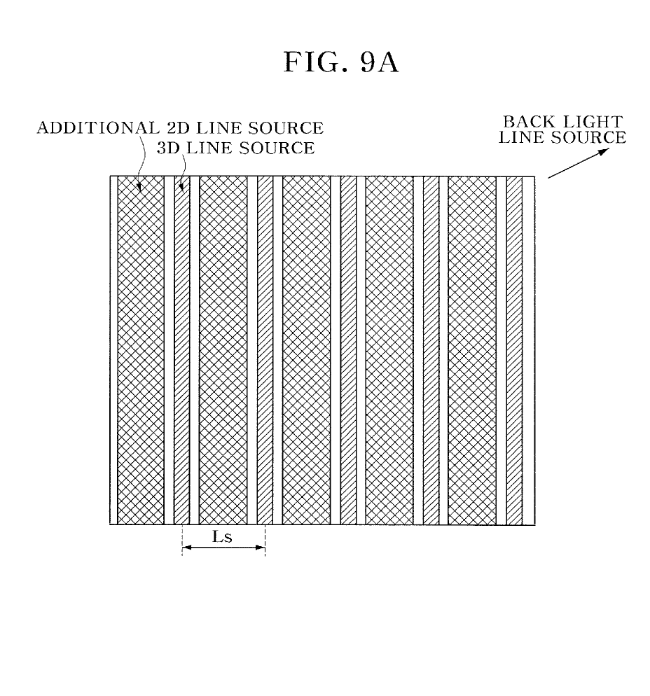

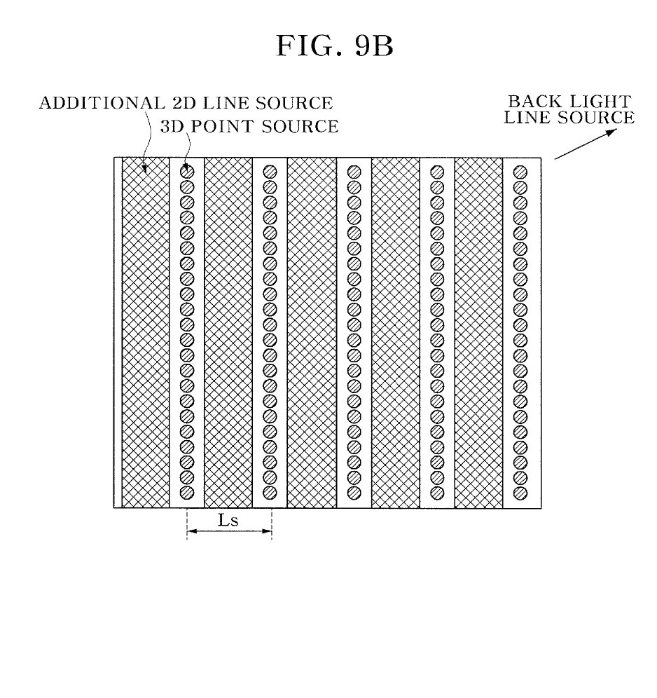

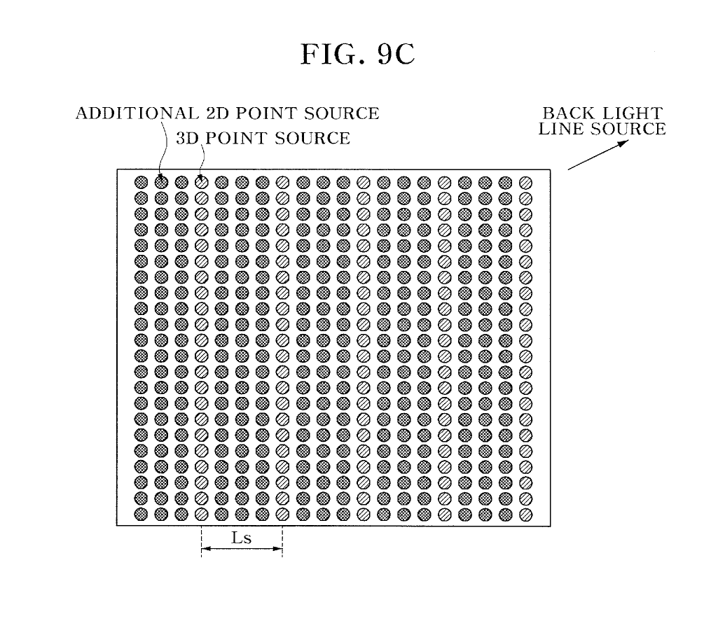

The 3D line sources and the additional 2D line sources which are arranged in the back light line source so as to form an effective line source for forming such a line source for 3D images or to form a uniform surface light source for 2D images may be implemented in a variety of methods. As another embodiment, in FIG. 9A, a case in which a 3D line source set in which line sources are arranged so as to be spaced apart from each other at regular intervals is formed and an additional 2D line source set additionally driven when implementing 2D images is formed between the 3D line sources is shown. In FIG. 9B as still another embodiment, 3D line source effects may be obtained using vertically arranged point light sources, and an additional 2D line source set may be formed between the 3D point source set in which the 3D point sources are vertically arranged so as to implement 2D images. In FIG. 9C as still another embodiment, the 3D point sources and the additional 2D point sources may be respectively driven, and a line source set or a uniform surface light source may be formed on the fixed light diffusion plate in order to drive 3D images. In FIGS. 9B and 9C, a case of using a circular point light source has been described, but other than this, point light sources having a variety of forms which can form the line source and the surface light source on the fixed light diffusion plate may obviously be used.

As described above, according to the embodiments of the present invention, an interval between two different types of line sources when adding the 2D line source to the back light line source may be made narrow, and the fixed light diffusion plate may be added between the display panel and the back light line source, and therefore the 3D mode and the 2D mode may be effectively and efficiently switched only based on whether the 2D line source is additionally operated without using a separate electronic 2D/3D switching method, and uniformity of light distribution of the back light may be improved in the 2D display mode.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An image display apparatus for switching a two-dimensional (2D) mode and a three-dimensional (3D) mode, the image display apparatus comprising:
a display panel in which pixels are arranged;
a back light line source arranged so as to be spaced apart from the display panel;
a fixed light diffusion plate arranged between the display panel and the back light line source; and
a control unit controlling to switch the 2D mode and the 3D mode,
wherein 3D line sources forming at least one set are arranged in the back light line source so as to be spaced apart from each other at regular intervals, and a 2D line source is arranged between the 3D line sources arranged so as to be spaced apart from each other.

2. The image display apparatus of claim 1, wherein, in at least two 3D line source sets, the 3D line sources forming each set and corresponding 3D line sources forming other sets are arranged adjacent to each other.

3. The image display apparatus of claim 1, wherein the display panel is a display panel of a non-emissive optical modulation scheme which includes a liquid crystal display (LCD), a Ferro electric liquid crystal display (FLCD), a digital micro-mirror display (DMD), and a grating light valve (GLV).

4. The image display apparatus of claim 1, wherein the 3D line source or the 2D line source is formed by point light sources.

5. The image display apparatus of claim 1, wherein the 3D line source and the 2D line source is formed by point light sources.

6. The image display apparatus of claim 1, wherein the control unit controls a switch so as to apply a voltage only to the 3D line source when driven in the 3D mode and apply a voltage to both the 3D line source and the 2D line source when driven in the 2D mode.
